(19) United States
(12) Patent Application Publication
(10) Pub. No.: US 2006/0130903 A1
(43) Pub. Date: Jun. 22, 2006

(54) Check valve

(76) Inventor: Frank Whittaker, Cheshire (GB)

Correspondence Address: EDWARDS & ANGELL, LLP, P.O. BOX 55874, BOSTON, MA, 02205, US

(21) Appl. No.: 10/534,941

(22) PCT Filed: Nov. 21, 2002
(86) PCT No.: PCT/GB02/05226

§ 371 Date: Sep. 29, 2005

(51) Int. Cl. F16K 15/02

(52) U.S. Cl. 137/538

(57) ABSTRACT

Disclosed is a new and improved check valve for use in applications such as spray drying, for example. The check valve assembly includes a valve member or piston mounted for movement within an axial bore defined within the valve body. The piston controls the flow of fluid through the valve body and opens by moving in an upstream direction opposite the direction of fluid flow so as to minimize the pressure drop across the valve assembly.

### BACKGROUND OF THE INVENTION

1. Field of the Invention

The subject invention relates to fluid control devices, and more particularly to, a check valve assembly with a valve member mounted to open by moving in an upstream direction opposite the direction of fluid flow so as to minimize the pressure drop across the valve assembly.

2. Background of the Related Art

A liquid spray system generally includes a pump, a pressure regulator or flow regulator, a check valve, and a spray nozzle or metering orifice. A prior art liquid spray system that includes a check valve and a spray nozzle is disclosed in commonly owned U.S. Pat. No. 5,323,807 to Gauld et al., the disclosure of which is herein incorporated by reference.

In a typical liquid spray system, the pump generally supplies liquid at an initial pressure to a flow regulator. The flow regulator then meters or controls the flow rate and/or adjusts the fluid pressure to a desired supply pressure for the spray system: The spray nozzle typically converts the metered fluid into a fine mist or other distribution of small droplets having a desired droplet size, volume distribution, and flow rate. For certain applications, the spray system also includes a check valve or shut-off valve which provides precision in the starting and stopping of the fluid flow, and minimizes dripping that can occur when the flow is suspended and/or initiated. The check/shut-off valve typically functions to suspend fluid flow at a predetermined pressure to prevent undesired spray quality and/or the dripping of excess spray after the liquid flow is suspended. The check/shut-off valve is also generally configured to open and start the spray only when a predetermined pressure is reached so as to achieve a consistent spray quality.

The operating or opening pressure of a typical check valve assembly is usually significantly lower than the nozzle operating pressure in order to minimize pump capacity or pressure requirements. For example, it may be necessary to supply 135 psi of pump pressure to hold a check valve open and to maintain 100 psi in the spray nozzle of a domestic oil burner. Thus, the pressure drop or operating pressure of such a check valve is 35 psi.

Pressure loss through or across a check valve is an important factor in valve design and use. Pressure loss is typically dependent upon the design of the valve and the nozzle or orifice opening, and results in a flow rate loss at the nozzle. The pressure loss can be due to friction between moving components of the valve assembly, contraction or expansion, and eddies formed as liquid flows through the valve assembly. The pressure loss associated with the valve generally increases with a decrease in the amount the valve opens and vise versa.

U.S. Pat. No. 4,172,465 to Dashner discloses a conventional check valve that has a semi-spherical valve member which is movable in an axial direction between a closed position in engagement with a conical valve seat and an open position spaced axially from the valve seat. Opening of the valve is dependent on the differential pressure across the valve seat. That is, the valve opens when the pressure applied to the semi-spherical valve member is sufficient to overcome the resistance of the biasing spring. As is commonplace among prior art check valves, the valve member moves in the downstream direction (i.e., in the direction of the fluid flow) away from the valve seat, thereby allowing fluid to pass between the periphery of the valve member and the valve body.

A disadvantage associated with the check valve disclosed in the Dashner patent, as well as other prior art check valves, is that because the valve opens towards the outlet, the valve spring pressure works against the inlet fluid pressure. As a result, at low operating pressures, the valve member has a tendency to oscillate and disrupt the ability to achieve the constant flow requirements of the spray system, and may cause damage to the valve sealing faces, thereby degrading the valve. Additionally, since the valve member remains at least partially within the fluid flow path, the available annular flow area is reduced, resulting in an increase in the flow velocity and pressure loss across the valve.

There is a need therefore, to provide a check valve assembly for use in a variety of applications that includes a valve member which opens by moving in an upstream direction, rather than a downstream direction, so as to minimize the pressure drop across the valve assembly, and to prevent valve oscillation at low operating pressures.

### SUMMARY OF THE INVENTION

The subject application is directed to a new and improved check valve for use in applications such as spray drying, for example. The check valve disclosed herein includes a valve body which defines an axial bore and has opposed upstream and downstream ends, and a piston member mounted for movement within the axial bore for controlling the flow of fluid through the body.

The upstream end of the valve body includes a fluid inlet and the downstream end includes a fluid outlet and defines an sealing face positioned adjacent to the axial bore. The valve body further includes at least one flow passage for facilitating fluid communication between the fluid inlet and the fluid outlet.

The piston member has opposed upstream and downstream ends and is mounted for movement between an open position and a closed position. The downstream end of the piston member is spaced from the interior sealing face of the valve body in the open position to permit fluid flow through the valve body. In the closed position, the downstream end of the piston member engages the interior sealing face of valve body to suspend the flow of fluid through the valve body. In a representative embodiment, the downstream end of the piston member includes a sealing ring for engagement with the interior sealing surface of the valve body.

The valve assembly further includes a biasing mechanism operatively associated with the piston member for urging the piston member to the closed position. In a representative embodiment, the biasing mechanism is disposed within the axial bore of the valve body adjacent to the upstream end of the piston member. Preferably, the biasing mechanism includes a spring element. It is presently envisioned that the spring element is a metal helical spring. Alternatively, the biasing mechanism can include a gas contained within the axial bore and compressed when the piston member is in the open position.

Preferably, a port is formed in the valve body, and the port extends radially from an exterior of the valve body to the axial bore. The port allows gas to be exhausted from the axial bore when the piston moves to the open position.

The subject disclosure is also directed to a valve assembly which includes a valve body that defines an axial bore and has opposed upstream and downstream ends. The upstream end of the valve body includes a fluid inlet and the downstream end includes a fluid outlet. The valve body also defines a series of flow passages which are positioned radially outward of the axial bore and extend axially between the fluid inlet and the fluid outlet;

The valve assembly further includes an elongated piston member and a biasing mechanism, each being disposed at least partially within the axial bore of the valve body. The piston member has opposed upstream and downstream ends and is mounted for movement between an open position and a closed position. The biasing mechanism is operatively associated with the piston member and for urges the piston member to the closed position.

The valve assembly further includes retainer element that is engaged with the downstream end of the valve body and defines an interior sealing face adjacent to the axial bore. The downstream end of the piston member is spaced from the interior sealing face of the retainer member in the open position to permit fluid flow through the valve body. However, in the closed position, the downstream end of the piston member engages with the interior sealing face of retainer member to suspend the flow of fluid through the valve body.

Those skilled in the art will readily appreciate that the subject check valve is adapted and configured to open in the upstream direction, opposite that of the product flow, to minimize the pressure drop across the valve assembly, and to prevent valve oscillation at low operating pressures. These and other unique features of the check valve disclosed herein will become more readily apparent from the following description, the accompanying drawings and the appended claims.

### BRIEF DESCRIPTION OF THE DRAWINGS

So that those having ordinary skill in the art to which the subject invention appertains will more readily understand how to make and use the same, reference may be had to the drawings wherein:

FIG. 1 is a side elevational view in cross-sectional of a prior art check valve having a cylindrical seating surface and a spherical valve member which opens by moving in the downstream direction which is the direction of fluid flow through the valve;

FIG. 2a is a side elevational view in cross-section illustrating the check valve assembly of the present disclosure engaged with a fluid spray nozzle for controlling the flow of fluid through the nozzle;

FIG. 2b is a plan view along line 2b-2b of FIG. 2a illustrating the spray nozzle;

FIG. 3a is a side elevation view in cross-section of the check valve assembly of the present disclosure with the piston disposed in a closed position biased by spring acting in the downstream direction;

FIG. 3b is a plan view of the downstream end of the check valve assembly of FIG. 3a; and

FIG. 3c is a plan view of the upstream end of the check valve of FIG. 3a illustrating the exhaust port extending through the valve body to the central core which houses the piston and biasing spring.

These and other features of the valve assembly of the subject invention will become more readily apparent to those having ordinary skill in the art from the following detailed description of preferred embodiments.

### DETAILED DESCRIPTION OF PREFERRED EMBODIMENTS

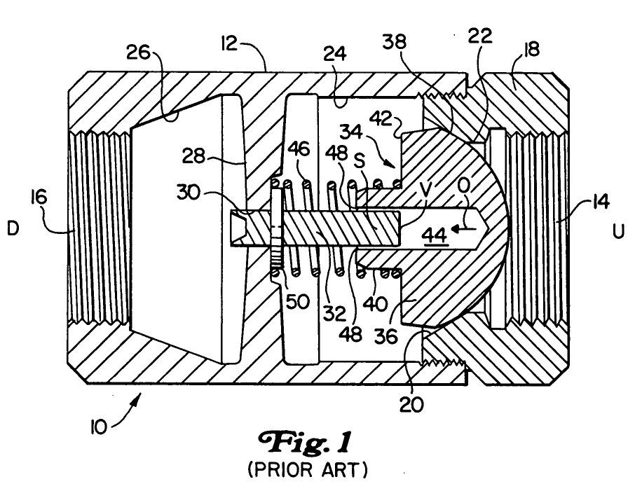

In the description which follows, as is common in the art to which the subject disclosure appertains, “upstream” shall refer to movement in a direction opposite the fluid flow, while “downstream” shall refer to movement in the direction of the fluid flow. In FIGS. 1, 2a and 3a the upstream and downstream ends of the nozzle are identified by reference characters U and D respectively.

Referring now to the drawings, there is illustrated in FIG. 1 a prior art check valve designated generally as reference numeral 10. Check valve 10 includes a generally tubular housing 12, preferably made of metal, through which fluid flows in an axial direction from an upstream inlet 14 to a downstream outlet 16. The inlet 14 is generally cylindrical and is located at the upstream end of an inlet fitting 18, threadably received in main housing member 12. The fitting 18 is formed with a conical valve seat 20 having a taper of approximately thirty degrees with respect to the axial center line of the valve 10. The smaller upstream opening 22 of the conical valve seat 20 has a cross-sectional area that corresponds substantially to the cross-sectional area of a pipe or tube (not shown) that would be threaded into the inlet 14. Immediately, downstream of valve seat 20, the housing 12 is formed with a generally cylindrical portion 24 and a conical portion 26 tapering inwardly from a diameter corresponding to the diameter of cylindrical portion 24 to a diameter corresponding to the diameter of the pipe (not shown) which would be threaded into outlet 16. That is the internal diameter of the outlet pipe is substantially the same as the diameter of the inlet pipe.

A relatively narrow wall 28 is formed at the downstream end of the cylindrical housing portion 24. An axial opening 30 is formed in wall 28 for receiving one end of a longitudinally extending cylindrical support element 32 which is securely held therein.

A valve member 34 is mounted within housing 12, which includes a semi-spherical portion 36 presenting an exposed semi-spherically shaped seating surface 38. Valve member 34 also includes a cylindrical sleeve portion 40 extending axially from the flat transverse surface 42 of the semi-spherical portion 36. The valve member 34 includes an axial opening 44 that extends through the sleeve portion 40 and into the semi-spherical portion 36, as shown in FIG. 1. The axial opening 44 receives the longitudinally extending support element 32 so that the valve member 34 is mounted therein for relative axial movement between a closed position at which the seating surface 38 engages the conical valve seat 20, and an open position at which the seating surface 38 is longitudinally spaced from the valve seat 20. A biasing spring 46 is interposed between the flat valve member surface 42 and the flange member 28 to urge the valve member 34 toward its closed position.

In operation, once the inlet fluid pressure exceeds the mechanical resistance imparted by biasing spring 46, valve member 34 moves in the downstream direction toward the open position, as indicated by directional arrow O. Fluid which has been received into the valve 10 through inlet 14 is then permitted to pass by seating surface 38 and through the housing 12 to outlet 16.

A disadvantage associated with check valve 10 is that since the valve opens in the downstream direction, the force imparted by valve spring 46 works in counteracting the fluid flow pressure. At low operating pressures, this can cause oscillations of the valve member 34 and therefore, effect the constant flow requirements of the sprayed fluid and can also cause damage to the valve sealing faces. Additionally, since the valve member 34 remains at least partially within the flow path for the fluid, it reduces the available annular flow area, which increases the flow velocity. An increase in flow velocity typically increases the pressure loss across the valve 10 and increases the component wear.

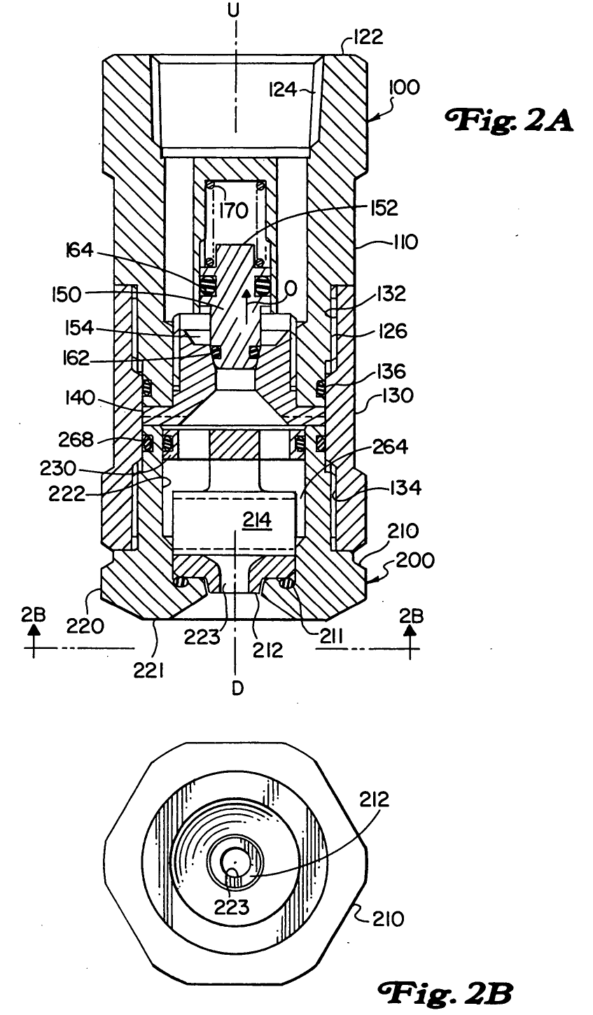

Referring now to FIGS. 2a and 2b, there is illustrated a check valve assembly constructed in accordance with a preferred embodiment of the subject disclosure and designated generally as reference numeral 100. As illustrated, check valve 100 is engaged with a spray nozzle assembly 200. The disclosed check valve assembly can be used in a variety of applications including, but not limited to, spray or liquid flow applications that include nozzles and orifices, such as fuel supply applications, industrial applications, agricultural applications and spray drying applications.

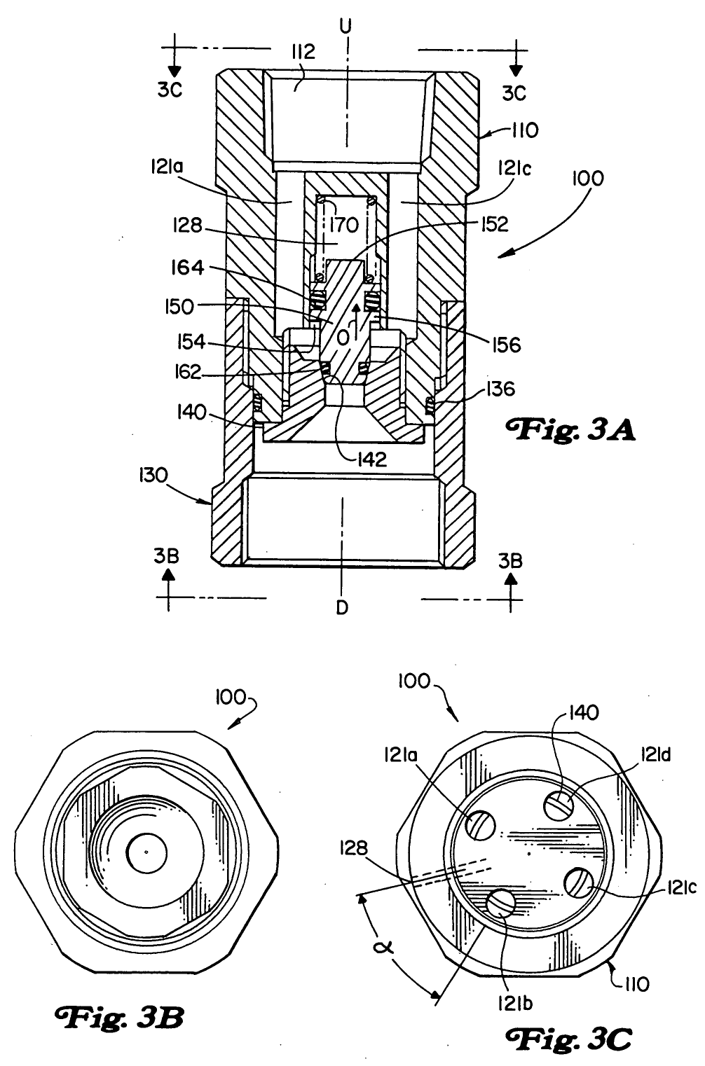

Check valve 100 is assembled from a plurality of components which include, among other things, a valve body 110, an adapter 130, and a valve retainer plate 140 which when assembled combine to form a valve housing having an interior valve chamber. Disposed within the interior valve chamber is a valve seat or piston 150 and a biasing spring 170. The piston 150 includes two O-ring gaskets 162 and 164 which are disposed within peripheral grooves formed in the piston. The internal components and operation of check valve 100 will be discussed in more detail with respect to FIGS. 3a through 3c.

The valve body 110 has a series of female threads 124 formed in the upstream end 122 which are configured for corresponding engagement with fluid supply tubing (not shown). The adapter 130 includes two sets of female threads 132 and 134. Threads 132 are adapted and configured for engaging with corresponding threads formed on the downstream end 126 of the valve body portion 110 and threads 134 engage with threads associated with spray nozzle 200.

Spray nozzle 200 primarily includes a nozzle body 210, a swirl unit 214 for facilitating the atomization of the fluid, and an orifice disc 212 for directing the discharge of the atomized fluid from the nozzle. Nozzle body 210 has a central bore 222 formed therein for receiving the orifice disc 212 and the swirl unit 214. Additionally, the downstream end 221 of nozzle body 210 defines a spray opening 223 for emitting an atomized spray therefrom.

The orifice disc 212 is disposed within the central bore 222 of the nozzle body 210 and is positioned adjacent to the discharge portion 220. An O-ring gasket 211 is provided between the orifice disc 212 and discharge portion 220 of the nozzle body 210. The gasket 211 provides a seal which prevents fluid from leaking around the periphery of the orifice disc 212 and between the orifice disc 212 and discharge portion 220 into spray opening 223.

In the assembled configuration, the adapter member 130 is threadably engaged with the nozzle body 210 so as to enclose the orifice disc 212 and swirl unit 214 within the bore 222 of the nozzle body 210. An adapter O-ring gasket 268 is disposed between the adapter member 130 and the nozzle body 210 for preventing fluid leakage from the assembled nozzle 200. The spray nozzle 200 further includes a locking plate 230 which is engaged with nozzle body 210.

Assembly of a conventional spray nozzle is complicated by the inability to properly maintain the alignment and positioning of the internal components when the nozzle body is being engaged with the adapter. Locking plate 230 provides a mechanism for positively securing the orifice disc 212 and swirl unit 214 in place and compressing the orifice O-ring gasket 211 prior to threadably engaging the nozzle body 210 with the adapter 218. The locking plate 230 is preferably manufactured from a suitable wear resistant material.

In operation, a pump (not shown) supplies liquid at an initial pressure to a flow regulator (not shown). The flow regulator then meters or controls the flow rate and/or adjusts the fluid pressure to the desired supply pressure for the check valve/spray nozzle assembly. Inlet tubing (not shown) supplies the pressurized fluid to check valve 100 which provides precision in the starting and stopping of the flow and minimizes dripping that can occur when the flow is suspended and/or initiated. Check valve 100 suspends the fluid flow at a predetermined pressure to prevent undesired spray quality and/or the dripping of excess spray after liquid flow is suspended. Check valve 100 is also configured to open and start the spray only when a predetermined pressure is reached to obtain a consistent spray quality.

Upon the opening of check valve 100, fluid is supplied at the desired pressure to spray nozzle 200. The liquid enters flow port 264 defined by the space between swirl unit 214 and nozzle body 210. The liquid feed enters the swirl chamber of the swirl unit 214 through a fluid receiving portion and a spiral or swirl motion is imparted thereto as known to those skilled in the art. The feed then exits the swirl chamber and is atomized by a spray orifice. Atomized feed exits the spray orifice of the swirl unit 214 and spray opening 223 of the nozzle body 210.

Referring now to FIGS. 3a-3c, there is illustrated check valve 100. As shown therein, valve body 120 houses the components that provide the shut-off capability, namely the piston 150, biasing spring 170 and the valve retainer plate 140. The valve body 120 has a ‘blind’ machined bore 128 into which the piston 150 and spring 170 are disposed. In the embodiment disclosed herein, the bore 128 has a ‘bleed’ hole 129 (see FIG. 3c) that allows the air to discharge as the spring 170 is compressed and the valve piston 150 is lifted. The bleed hole 129 is spaced from inlet flow passages 121a-122d by an angle “a”.

The piston 150 has at an upstream end 152 a location diameter that is adapted and configured for insertion into biasing spring 170. Piston 150 includes two O-ring gaskets 162 and 164. O-ring gasket 162 prevents the fluid product being sprayed from exiting the nozzle when piston 150 is in the closed position, whereas the O-ring gasket 164 prevents ingress of sprayed product into the central bore 128, thus ensuring correct operation of the biasing spring 170.

The valve retainer plate 140 is screwed into corresponding threads on the valve body 110 and completes the valve sub-assembly. Valve retainer plate 140 compresses the spring 170 to the correct operating length and provides a valve seat 142 which is adapted and configured for engagement with piston 150 and O-ring gasket 162.

Fluid enters the valve body 110 through inlet bore 112 and is channeled through flow passages 121a-121d. On reaching the piston 150, the fluid is prevented from continuing through the assembly due to the sealing between the O-ring gasket 162 and the seat 142 on the valve retainer plate 140.

Providing that the pressure of the sprayed product is lower than the force due to the compression of the biasing spring 170, no product will pass the O-ring gasket 162. However, once the pressure within the chamber 154 is raised above the pre-set spring pressure, then the biasing spring 170 is further compressed within the bore 128 by the fluid acting on shoulder 156, thus lifting the piston 150 and allowing the progress of the fluid through valve 100 into nozzle 200.

As long as the fluid pressure of the sprayed product remains above the compression pressure of the spring 170 then the nozzle 100 will continue to spray product. Should the pressure be reduced, or the feed pump stopped, then the spring 170 pushes the piston 150 back onto the seat 142 of the retainer plate 140, shutting off the feed to the nozzle 200.

An advantageous feature of the check valve assembly of the present disclosure is the opening of the piston 150 in a direction opposite to the flow of fluid through the nozzle 200. Valve members or pistons are normally lifted from the valve seat in the direction of the flow (i.e., downstream). In check valve 100, the valve seat or piston 150 is pressed in the opposite direction to the product flow or in the upstream direction as indicated by directional arrow “O”. This feature provides a number of distinctive advantages over conventional valve operation. First, by removing the piston 150 from within the fluid flow path, the annular flow area is maximized. Since the flow area is not restricted by the piston, the flow velocity is not increased locally in the sealing region and thereby reduces the likelihood that the O-ring gasket 162 will be ‘rolled’ out of the groove formed in piston 150.

Additionally, conventional check valves that open in the downstream direction have a tendency to oscillate at low operating pressures. This is due to the fact that the valve spring pressure works in counter-acting the product flow pressure. The oscillation of the valve seat can dramatically affect the constant flow requirement of the sprayed product and also cause damage to the sealing faces.

It envisioned that the biasing of the valve piston can be accomplished by a variety of alternative methods. In addition to or in place of the helical spring, other metal springs, elastomeric or foam elements can be positioned with the central bore. In an alternative embodiment, the valve body is constructed without the bleed hole which exhausts the central bore. As a result, air which is contained within the central bore is compressed when the piston moves in the upstream direction, thereby acting as a spring mechanism. It is also envisioned that the air within the central bore can be replaced with a gas which exhibits improved restoration properties.

Those skilled in the art will readily appreciate that various materials can be used for the construction of the valve components disclosed herein. Check valves wear largely depends upon its corrosion and erosion resistance. Corrosion occurs when the liquid feed and valve component material are chemically incompatible. Erosion results from the liquid feed with its abrasive solids passing through the flow passages at high velocities and physically removing component material. Corrosion problems can often be avoided or at least greatly reduced by determining the chemical characteristics of the liquid feed. Various materials can then be used based upon their ability to resists chemical and physical attack. Material possibilities are too numerous to list, but the materials disclosed herein are intended for illustrative purposes only and are not intended to limit the scope of the disclosure

While the invention has been described with respect to preferred embodiments, those skilled in the art will readily appreciate that various changes and/or modifications can be made to the invention with departing from the spirit or scope of the invention as defined by the appended claims.

1. A valve assembly comprising:
a) a valve body defining an axial bore and having opposed upstream and downstream end portions, the upstream end portion including a fluid inlet, the downstream end portion including a fluid outlet and defining an sealing face positioned adjacent to the axial bore, the valve body further including at least one flow passage for facilitating fluid communication between the fluid inlet and the fluid outlet;
b) an elongated piston member disposed at least partially within the axial bore of the valve body and having opposed upstream and downstream ends, the piston member mounted for movement between an open position and a closed position, wherein the downstream end of the piston member is spaced from the interior sealing face of the valve body in the open position to permit fluid flow through the valve body, and the downstream end of the piston member engages the interior sealing face of valve body to suspend the flow of fluid through the valve body in the closed position; and
c) biasing means operatively associated with the piston member for urging the piston member to the closed position when a force impart by the biasing means on the piston member exceeds an opposing pressure imparted on the piston member by fluid within the flow passage.

2. A valve assembly as recited in claim 1, wherein a port is formed in the valve body, and the port extends radially from an exterior of the valve body to the axial bore allowing gas to be exhausted therefrom.

3. A valve assembly as recited in claim 1, wherein the biasing means includes a spring element.

4. A valve assembly as recited in claim 3, wherein the biasing means is a helical spring.

5. A valve assembly as recited in claim 1, wherein the biasing means includes a gas contained within the axial bore and compressed when the piston member is in the open position.

6. A valve assembly as recited in claim 1, wherein the downstream end of the piston member includes a sealing ring for engagement with the interior sealing surface of the valve body.

7. A valve assembly as recited in claim 1, wherein the biasing means is disposed within the axial bore of the valve body adjacent to the upstream end of the piston member.

8. A valve assembly comprising:
a) a valve body defining an axial bore and having opposed upstream and downstream end portions, the upstream end portion including a fluid inlet, the downstream end portion including a fluid outlet, the valve body further defining flow passages positioned radially outward of the axial bore and extending axially between the fluid inlet and the fluid outlet;
b) an elongated piston member disposed at least partially within the axial bore of the valve body and having opposed upstream and downstream ends, the piston member mounted for movement between an open position and a closed position;
c) biasing means operatively associated with the piston member for urging the piston member to the closed position when a force impart by the biasing means on the piston member exceeds an opposing pressure imparted on the piston member by fluid within the flow passage; and
d) a retainer element engage with the downstream end portion of the valve body and defining an interior sealing face adjacent to the axial bore, the downstream end of the piston member is spaced from the interior sealing face of the retainer member in the open position to permit fluid flow through the valve body, the downstream end of the piston member engages the interior sealing face of retainer member to suspend the flow of fluid through the valve body in the closed position.

9. A valve assembly as recited in claim 8, wherein a port is formed in the valve body, and the port extends radially from an exterior of the valve body to the axial bore allowing gas to be exhausted therefrom.

10. A valve assembly as recited in claim 8, wherein the biasing means includes a spring element.

11. A valve assembly as recited in claim 10, wherein the biasing means is a helical spring.

12. A valve assembly as recited in claim 8, wherein the biasing means includes a gas contained within the axial bore and compressed when the piston member is in the open position.

13. A valve assembly as recited in claim 8, wherein the downstream end of the piston member includes a sealing ring adapted and configured for engagement with the interior sealing surface of the retainer element.

14. A valve assembly comprising:
a) a valve body having upstream and downstream end portions and defining an axial core and an axis for the valve assembly, the valve body further defining flow passages extending therethrough between the upstream and downstream end portions, the downstream end portion defining a valve seating surface adjacent to the axial core;
b) a piston mounted for axial movement within the axial core between and open and a closed position; and
c) a biasing element disposed within the axial core and operatively associated with the piston, the biasing element for urging the piston in the closed position, the piston is engaged with the seating surface of the valve body in the closed position so as to prevent fluid flow through the valve, fluid pressure urging the piston in the upstream direction away from the seating surface of the valve body to the open position.

15. A valve assembly as recited in claim 14, wherein a port is formed in the valve body, and the port extends radially from an exterior of the valve body to the axial bore allowing gas to be exhausted therefrom.

16. A valve assembly as recited in claim 14, wherein the biasing element is a metal spring.

17. A valve assembly as recited in claim 16, wherein the biasing element is a helical spring.

18. A valve assembly as recited in claim 14, wherein the biasing element includes a gas contained within the axial bore and compressed when the piston member in the open position.
